(19) United States
(12) Patent Application Publication
(10) Pub. No.: US 2026/0233513 A1
(43) Pub. Date: Aug. 13, 2026

(54) PRINTING SYSTEM, PRINTING METHOD, AND MIXED POWDER

(71) Applicant: BROTHER KOGYO KABUSHIKI KAISHA, Nagoya (JP)

(72) Inventors: Yugo FUKUI, Kariya (JP); Goro OKADA, Nagoya (JP)

(21) Appl. No.: 19/638,357

(22) Filed: Apr. 3, 2026

Related U.S. Application Data
(63) Continuation of application No. PCT/JP2024/034635, filed on Sep. 27, 2024.

(30) Foreign Application Priority Data
Oct. 11, 2023 (JP) 2023-175982

(51) Int. Cl. B41J 2/005; B41F 16/00; B41J 2/01; B41J 2/21; B41J 11/00; B41M 3/00; B41M 5/025; B41M 5/03; C09D 11/34

(52) U.S. Cl. CPC B41J 2/0057; B41F 16/0046; B41J 2/2117; B41J 11/0015; B41M 3/008; B41M 5/0256; B41M 5/03; C09D 11/34; B41J 2002/012; B41M 2205/02

(57) ABSTRACT

A printing system includes an inkjet head and a powder application apparatus. The inkjet head includes a first nozzle configured to eject color ink to a first image region of a transfer film to form an image to be transferred to a transfer medium. The powder application apparatus is configured to apply a white powder and an adhesive powder onto the color ink ejected to the first image region.

### REFERENCE TO RELATED APPLICATIONS

This is a Continuation Application of International Application No. PCT/JP 2024/034635 filed on Sep. 27, 2024, which claims priority from Japanese Patent Application No. 2023-175982 filed on Oct. 11, 2023. The entire content of each of the prior applications is incorporated herein by reference.

### BACKGROUND ART

A printing apparatus including an inkjet head for color ink and an inkjet head for white ink is known.

### SUMMARY

In a printing apparatus, an image including a color ink layer is formed by ejecting color ink onto a transfer medium, and a base including a white ink layer is formed by ejecting white ink onto the color ink layer. Further, a hot melt resin powder is applied onto the base, and then melted and solidified to form a transfer sheet. Then, the transfer sheet is placed on a transfer medium and heated and pressed to transfer the base and the image from the transfer sheet to the transfer medium.

In the above-described example, the base is interposed between the image and the transfer medium, thereby reducing the influence of the color of the transfer medium on the image. However, the white ink forming the base may be more susceptible to precipitation of the pigment or drying than the color ink. When some measure is taken to reduce the precipitation or drying of the pigment of the white ink, any of the following effects may occur: the cost of the printing apparatus increases, the running cost increases due to the necessity of maintenance, or the productivity decreases due to a decrease in the time available for printing.

In view of the foregoing, an example of an object of this disclosure is to provide a printing system, a printing method, and a mixed powder configured to reduce the above-described influence.

According to one aspect, this specification discloses a printing system. The printing system includes an inkjet head and a powder application apparatus. The inkjet head includes a first nozzle configured to eject color ink to a first image region of a transfer film to form an image to be transferred to a transfer medium. Thus, the image to be transferred to the transfer medium is formed in the first image region of the transfer film. The powder application apparatus is configured to apply a white powder and an adhesive powder onto the color ink ejected to the first image region. Thus, the white powder and the adhesive powder are applied onto the color ink ejected to the first image region.

According to another aspect, this specification also discloses a printing method. A printing method includes ejecting color ink to a first image region of a transfer film to form an image to be transferred to a transfer medium; and applying a white powder and an adhesive powder onto the color ink ejected to the first image region.

According to still another aspect, this specification also discloses a mixed powder to be applied onto an image to be transferred to a transfer medium. The mixed powder includes a white powder and an adhesive powder. The white powder is to be applied onto color ink ejected to a transfer film from an inkjet head. The adhesive powder causes the white powder to adhere to the transfer medium.

Since liquid white ink is not used, the printing system, the printing method, and the mixed powder of the present disclosure reduce one or more of the disadvantages of an increase in the cost of a printing apparatus, an increase in running cost, and a decrease in productivity, which are caused when the liquid white ink is used.

### BRIEF DESCRIPTION OF DRAWINGS

FIG. 1 is a block diagram illustrating a configuration and functions of a printing system 100.

FIG. 2 illustrates a printing apparatus 102 used in the printing system 100.

FIGS. 3A and 3B illustrate examples of a white powder and an adhesive powder.

FIG. 4 is a flowchart illustrating an example of operation of the printing system 100.

FIGS. 5A, 5B and 5C illustrate layers formed on a transfer film when the printing system 100 operates in accordance with the flowchart of FIG. 4.

FIG. 6 illustrates a configuration of a printing apparatus 102A used in the printing system 100.

FIGS. 7A, 7B and 7C illustrate layers formed on a transfer film when the printing system 100 including the printing apparatus 102A performs an image forming step and a powder application step.

FIG. 8 illustrates a configuration of a printing apparatus 102B used in the printing system 100.

FIGS. 9A, 9B and 9C illustrate layers formed on a print medium when an image is directly formed on the print medium by the printing system 100 including the printing apparatus 102B.

### DESCRIPTION

Embodiments according to the present disclosure will be described in detail below with reference to the drawings. In the following description, the same reference numerals are given to the same or corresponding elements throughout the drawings, and a repeated description will be omitted.

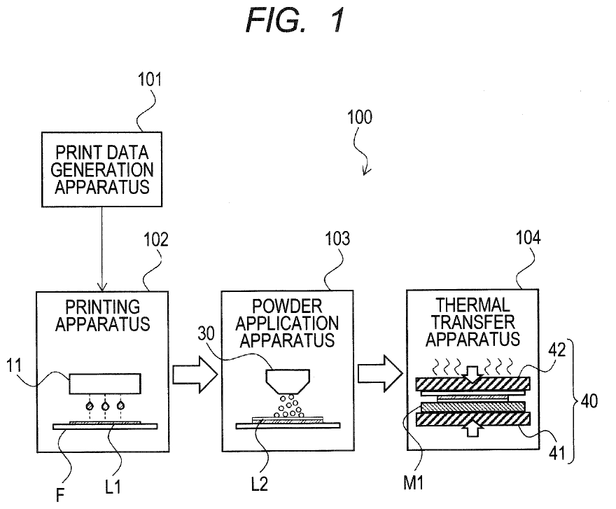

FIG. 1 is a block diagram schematically showing the configuration and functions of a printing system 100. The printing system 100 forms an image on a transfer medium M1 by transferring an image printed on a transfer film F to the transfer medium M1 such as a towel, clothes, and bag. For this purpose, the printing system 100 includes a print data generation apparatus 101, a printing apparatus 102, a powder application apparatus 103, and a thermal transfer apparatus 104.

Although the printing system 100 according to this embodiment includes the print data generation apparatus 101, the printing apparatus 102, the powder application apparatus 103, and the thermal transfer apparatus 104, one or both of the print data generation apparatus 101 and the thermal transfer apparatus 104 may be omitted. Although the apparatuses 101 to 104 are illustrated as independent apparatuses in FIG. 1, some or all of them may be integrated into one apparatus. For example, the printing apparatus 102 and the powder application apparatus 103 may be configured as a single apparatus.

The print data generation apparatus 101 generates print data relating to an image to be printed on the transfer film F by the printing apparatus 102 based on image data. For example, the print data generation apparatus 101 generates print data by executing various processes on image data to be used, such as resolution conversion processing for converting the resolution in accordance with the specification of the printing apparatus 102, color conversion processing for converting the color data in accordance with the specification of the printing apparatus 102, and halftone processing for reproducing the gradation of the image data.

The image data used in the print data generation apparatus 101 may be image data generated by the print data generation apparatus 101 or image data input to the print data generation apparatus 101 from the outside. The print data generation apparatus 101 includes a communication interface, and transmits the generated print data to the printing apparatus 102 by wire or wireless via the communication interface.

The printing apparatus 102 includes a communication interface and receives print data transmitted from the print data generation apparatus 101. The printing apparatus 102 is an inkjet printing apparatus that ejects droplets such as color ink from an inkjet head 11. The printing apparatus 102 executes an “image forming step” of forming an image by ejecting ink onto the surface of the transfer film F based on the print data.

The transfer film F used in the printing system 100 of the present disclosure is formed of a roll film in which a long film of several meters or more is wound in a roll shape. Then, the printing of the image by the printing apparatus 102 and the application (deposition) of the powder by the powder application apparatus 103 are successively performed on the transfer film F drawn out from the roll film. However, the structure of the transfer film F is not limited to this. For example, a cut film cut into a particular size such as A4 size or A3 size may be used as the transfer film F.

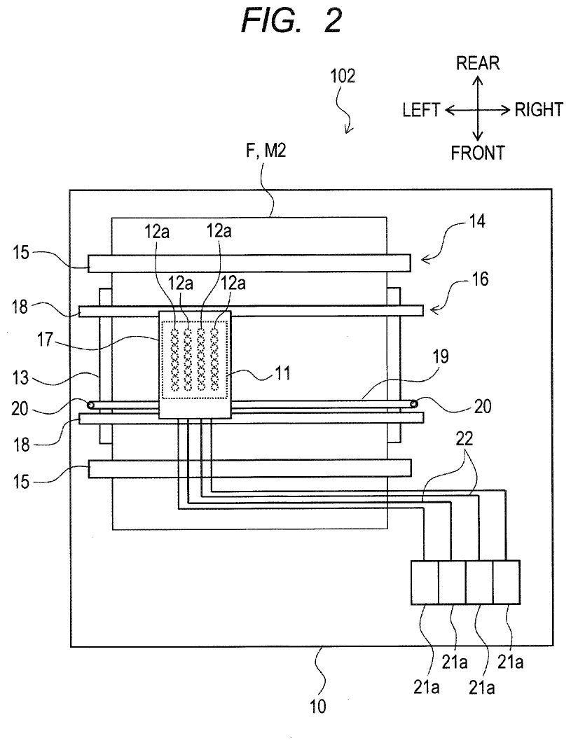

The printing apparatus 102 will be described in more detail. FIG. 2 illustrates the printing apparatus 102. The printing apparatus 102 is, for example, a serial head type printing apparatus, and a step of forming an image by ejecting a plurality of types of inks while the inkjet head 11 is moving and a step of conveying the transfer film F are alternately performed. Hereinafter, the conveying direction of the transfer film F is referred to as a front-rear direction. Of the two directions perpendicular to the front-rear direction, the moving direction in which the inkjet head 11 moves is referred to as a left-right direction, and the remaining one direction is referred to as an upper-lower direction. However, the direction in which the printing apparatus 102 is arranged is not limited to this.

The inkjet head 11 of the printing apparatus 102 is housed in a housing 10 of the printing apparatus 102. The inkjet head 11 includes a nozzle row in which a plurality of first nozzles 12a opened downward for ejecting ink are arranged in the front-rear direction. The printing apparatus 102 of the present disclosure includes a plurality of nozzle rows, and at least one nozzle row is formed in the inkjet head 11 for each color of ink, for example.

The inkjet head 11 includes a driving element for each of the first nozzles 12a. The driving element is a piezoelectric element, a heating element, or an electrostatic actuator, for example, and applies pressure for ejecting ink from the corresponding first nozzle 12a to ink in the inkjet head 11 by driving. The first nozzles 12a shown in FIG. 2 are nozzles for ejecting at least color ink (including black ink). That is, the first nozzles 12a included in each nozzle row ejects ink of a color corresponding to the nozzle row among four colors of cyan, yellow, magenta, and black, for example.

The printing apparatus 102 includes a platen 13 disposed to face the inkjet head 11. The platen 13 is located below the inkjet head 11 at a particular distance, and supports the transfer film F (or a print medium M2 described later) from below with a flat upper surface.

The printing apparatus 102 includes a conveyance device 14 for conveying the transfer film F on the platen 13. The conveyance device 14 includes, for example, two conveyance rollers 15 and a conveyance motor. The two conveyance rollers 15 are arranged in front and rear apart from each other with the platen 13 interposed between the conveyance rollers 15, and are connected to the rotation shaft of the conveyance motor via a reduction gear. Therefore, when the conveyance motor is driven, the two conveyance rollers 15 rotate about their axes, and the transfer film F on the platen 13 is conveyed in the front-rear direction. The printing apparatus 102 may include a mechanism for moving the platen 13 instead of the two conveyance rollers 15. In this case, the transfer film F is supported by the platen 13 and is conveyed together with the platen 13.

The printing apparatus 102 includes a scanning device 16 for moving the inkjet head 11 in the left-right direction. The scanning device 16 includes a carriage 17, two guide rails 18, an endless belt 19, and a scanning motor. The carriage 17 is a housing for supporting the inkjet head 11. The two guide rails 18 extend in the left-right direction across the platen 13, and are disposed in front and rear apart from each other with the inkjet head 11 interposed between the two guide rails 18. The carriage 17 is supported by the two guide rails 18 so as to be movable in the left-right direction.

The endless belt 19 is wound around two pulleys 20 disposed in the vicinity of the left and right ends of one guide rail 18, and is connected to the carriage 17 at a particular position. The rotating shaft of the scanning motor is connected to either the right or left pulley 20 via a reduction gear. Therefore, in the scanning device 16, when the scanning motor is rotated, the endless belt 19 travels, and the carriage 17 supporting the inkjet head 11 moves in the left-right direction along the guide rails 18.

The printing apparatus 102 includes a plurality of tanks 21a for storing inks of the respective colors to be supplied to the inkjet head 11. For example, the printing apparatus 102 includes four tanks 21a for storing inks of respective colors of cyan, yellow, magenta, and black. One end of a flexible tube 22 is connected to each tank 21a, and the other end of the tube 22 is connected to an ink supply port of the inkjet head 11. Thus, the ink in the tank 21a is sent to the inkjet head 11 through the tube 22.

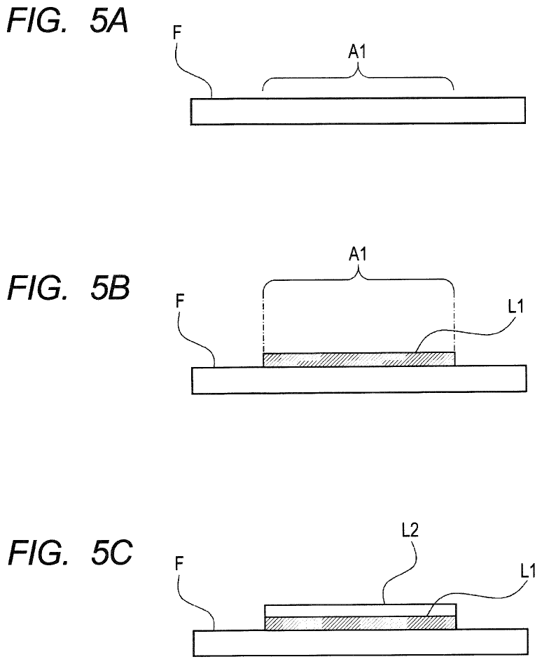

The printing apparatus 102 forms an image by ejecting color ink from the first nozzles 12a to a first image region A1 (see FIG. 5A) on one main surface of the transfer film F supported on the platen 13. The transfer film F on which the image is formed is conveyed from the printing apparatus 102 and sent to the powder application apparatus 103. The transfer film F may be automatically conveyed from the printing apparatus 102 to the powder application apparatus 103 by a conveyor installed between the two apparatuses, or may be manually picked up from the platen 13 and set at a particular position of the powder application apparatus 103.

The configuration of the printing apparatus 102 shown in FIG. 2 is an example, and the configuration of the printing apparatus 102 is not limited to that shown in FIG. 2. Although the configuration of the serial head system is exemplified as the printing apparatus 102, the present disclosure is not limited to this. For example, a line head type configuration may be employed in which nozzles are arranged over the entire width of the printing area or more and the head is fixedly arranged without moving (scanning).

The powder application apparatus 103 performs a “powder application step” of applying powder onto the transfer film F on which an image is formed, which is conveyed from the printing apparatus 102. For this purpose, the powder application apparatus 103 includes, for example, a drum 30 for storing powder and applying powder to the transfer film F. For example, as shown in FIG. 1, an opening for discharging powder is formed on the bottom of the drum 30, and while the transfer film F passes below the drum 30, the powder is sprinkled through the opening onto the transfer film F. The powder application apparatus 103 may include a rotating brush for removing excess powder from the powder applied onto the transfer film F, a heater for applying heat to the powder applied onto the transfer film F, and so on, in addition to the drum.

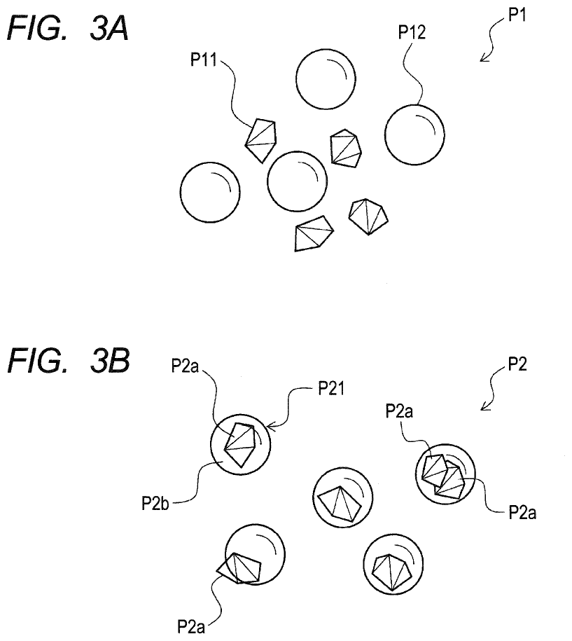

The powder stored in the drum 30 includes a white powder and an adhesive powder. The white powder is a powder to be applied onto the color ink ejected from the inkjet head 11, and forms a base of an image to be transferred. The adhesive powder serves to cause the white powder and the image formed by the color ink to adhere to the transfer medium M1. FIGS. 3A and 3B illustrate examples of such white powder and adhesive powder.

The powder shown in FIG. 3A is a mixed powder P1 in which a white powder and an adhesive powder are mixed. The white powder is a plurality of white particles P11 containing, for example, titanium oxide (TiO2) as a coloring material exhibiting white color. The white particles P11 may be primary particles of titanium oxide crystals or aggregated particles formed by aggregating a plurality of the primary particles. The white particles P11 may contain other materials in the coloring material such as titanium oxide.

The adhesive powder is a plurality of adhesive particles P12 which are particles made of an adhesive that is solid at room temperature. For example, a hot-melt powder mainly including a thermoplastic polymer, which exhibits adhesion when heated to a particular temperature, may be used as the adhesive powder. Specifically, a powder containing urethane particles, acrylic particles, polyester particles, polyamide particles, or a mixture of these particles may be used as the adhesive powder. The color of the adhesive particles P12 is not particularly limited as long as the adhesive particles P12 are white or transparent at least after the thermal transfer to the transfer medium M1, and the color before the thermal transfer may be a color different from any of white and transparent.

As the white particles P11 and the adhesive particles P12, for example, particles having the following relationship of specific gravity and average particle diameter may be used. That is, the specific gravity of the white particles P11 in the mixed powder P1 is larger than the specific gravity of the adhesive particles P12, and the average particle diameter of the white particles P11 is smaller than the average particle diameter of the adhesive particles P12. In this case, the weight of one of the white particles P11 is close to the weight of one of the adhesive particles P12. This reduces the occurrence of density unevenness in a state where the white powder and the adhesive powder are mixed in the mixed powder P1.

The method of determining the average particle diameter is not particularly limited. As an example, the particle diameter when the percent passing by mass is measured at the same percent (median diameter when set to 50%) may be used for the white particles P11 and the adhesive particles P12.

The powder shown in FIG. 3B is a white adhesive powder P2 which is a plurality of adhesive particles P21 containing a white coloring material P2a. In the adhesive particles P21, the coloring material P2a is entirely or at least partially covered with adhesive P2b. The coloring material P2a may be, for example, fine particles made of the same material as the white particles P11 described with reference to FIG. 3A. The adhesive P2b may be made of the same material as the adhesive particles P12 described with reference to FIG. 3A.

The adhesive particles P21 exhibit white color and exhibit adhesion at a particular temperature. Therefore, the white adhesive powder P2, which is a plurality of the adhesive particles P21, forms a white powder and an adhesive powder. Use of such white adhesive powder P2 reduces the occurrence of density unevenness of the white coloring material and the adhesive in a white adhesive layer L2 (see FIG. 5C) described later. The color of the adhesive particles P21 may be white or transparent at least after the thermal transfer to the transfer medium M1, as in the case of the adhesive particles P12 in FIG. 3A, and the color before the thermal transfer is not particularly limited.

In the following description, the mixed powder P1 shown in FIG. 3A is used as the powder used in the powder application apparatus 103, but the white adhesive powder P2 shown in FIG. 3B may be used. Alternatively, a powder obtained by mixing the mixed powder P1 and the white adhesive powder P2 may be used.

The powder application apparatus 103 according to the present disclosure applies the above-described white powder and adhesive powder onto the transfer film F. Specifically, the transfer film F on which the image is formed in the first image region A1 passes below the drum 30. Thus, the white powder and the adhesive powder stored in the drum 30 are applied onto the color ink ejected to the first image region A1 on the transfer film F.

In a case where the powder application apparatus 103 includes a rotating brush downstream of the drum 30, the excessive powder applied onto the ink may be removed by brushing the surface of the transfer film F. In a case where the powder application apparatus 103 includes a heater downstream of the drum 30 or the rotating brush, the transfer film F may be heated. When the transfer film F is heated, the adhesive powder applied onto the ink of the first image region A1 melts, and the adhesive is fixed on the transfer film F together with the white powder.

The transfer film F on which the white powder and the adhesive are fixed is cooled to such a degree that the molten adhesive is resolidified, and then sent to the thermal transfer apparatus 104.

The thermal transfer apparatus 104 transfers, to the transfer medium M1, the image on the transfer film F to which the powder is applied by the powder application apparatus 103. For this purpose, the thermal transfer apparatus 104 includes a heat press 40. The heat press 40 includes, for example, a lower platen 41, an upper platen 42, and a heater mounted in the upper platen 42. Then, the transfer medium M1 is placed on the lower platen 41, and the transfer film F is placed at an intended position of the transfer medium M1. At this time, the transfer film F is placed with the main surface having the first image region A1 facing downward (that is, the main surface is facing the transfer medium M1).

In this state, the upper platen 42 is lowered, and the transfer medium M1 and the transfer film F are sandwiched between the lower platen 41 and the upper platen 42. Thereafter, the heater is driven to heat the transfer medium M1 and the transfer film F. Thus, the adhesive is melted again, and the image on the transfer film F is transferred to the transfer medium M1. The heater may be heated in advance.

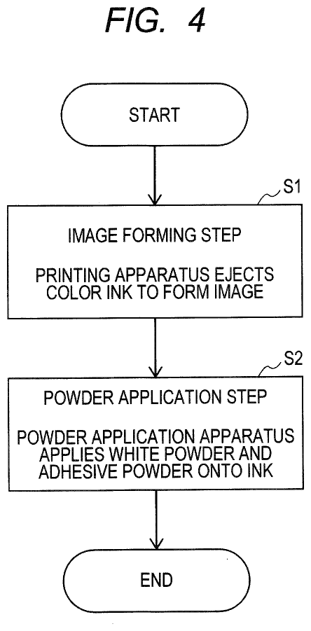

Next, the operation of the printing system 100 will be described. FIG. 4 is a flowchart showing an example of the operation of the printing system 100, and particularly shows the operation of the printing system 100 in the image forming step in the printing apparatus 102 and the powder application step in the powder application apparatus 103. FIGS. 5A to 5C illustrate layers formed on the transfer film F when the printing system 100 operates in accordance with the flowchart of FIG. 4.

As shown in FIG. 4, the printing apparatus 102 ejects color ink from the first nozzles 12a of the inkjet head 11 based on print data to form an image on the transfer film F (step S1). As shown in FIGS. 5A and 5B, a region on one main surface of the transfer film F where an image is formed is referred to as the first image region A1. In this case, the printing apparatus 102 forms an image by ejecting color ink onto the first image region A1 of the transfer film F. In this manner, the printing apparatus 102 performs the “image forming step”. By executing this step, as shown in FIG. 5B, a color ink layer L1 including the ejected color ink is formed on the transfer film F.

Next, the powder application apparatus 103 applies the white powder and the adhesive powder onto the color ink ejected to the first image region A1 of the transfer film F (step S2). That is, the transfer film F passes below the drum 30 before the surface of the color ink layer L1 is dried. Thus, the white powder and the adhesive powder are applied onto the color ink layer L1 formed in the first image region A1. In this manner, the powder application apparatus 103 performs the “powder application step”.

By executing this step, a white adhesive layer L2 including a white coloring material and an adhesive is formed on the color ink layer L1 as shown in FIG. 5C. The white adhesive layer L2 is not formed on the surface other than the color ink layer L1. FIG. 5C schematically shows a state where the transfer film F is heated after the white powder and the adhesive powder are applied, and the adhesive powder is melted and fixed on the transfer film F.

As can be seen from the above description, according to the printing system 100 of the present embodiment, after the first nozzles 12a of the printing apparatus 102 eject the color ink onto the transfer film F, the powder application apparatus 103 applies the white powder and the adhesive powder onto the color ink. Thus, the color ink layer L1 forming an image is formed on the transfer film F, and the white adhesive layer L2 of the white powder and the adhesive powder is formed on the color ink layer L1. When the layers L1 and L2 are transferred to the transfer medium M1, an image is formed on the transfer medium M1 with the white adhesive layer L2 as a base.

As described above, the printing system 100 of the present embodiment does not use the liquid white ink for forming the base of the image to be transferred to the transfer medium M1. This reduces at least any of the effects of an increase in the cost of the printing apparatus, an increase in the running cost, and a decrease in productivity, as in the case of using the liquid white ink.

Here, the influence of the white ink on the printing apparatus 102 will be described in more detail. Many kinds of white inks include a liquid solvent containing a substance having a high specific gravity such as titanium oxide as a white coloring material. In such white ink, the coloring material tends to precipitate in the solvent in the inkjet head, the ink flow path, the tank, and the cartridge, for example, of the printing apparatus. When the coloring material precipitates, the distribution of the coloring material in the solvent becomes uneven, and the concentration of the solvent and the viscosity of the ink also become uneven, and such unevenness may cause ink ejection failure in the inkjet head. Further, when the coloring material precipitates, a supernatant ink containing an insufficient amount of the coloring material is ejected at the time of printing, which may cause a deterioration in the quality of the image.

A skilled person has taken the following measures to solve these issues. That is, in known printing apparatuses, a method of periodically circulating the white ink in the white ink flow path so that the coloring material does not precipitate in the solvent, a method of stirring the white ink by a stirring member disposed in a tank for the white ink, or a method of stirring the white ink by having a user hold the tank by hand and shake the tank are adopted.

In order to reduce ejection failure and deterioration in image quality, known printing apparatuses frequently perform various maintenance operations such as wiping of cleaning the nozzle surface of the inkjet head, flushing of driving an actuator of the inkjet head to eject ink from the nozzle, and purging of applying a positive pressure or a negative pressure to the nozzle by a pump to forcibly discharge ink in the nozzle.

Although these methods are effective to a certain degree in solving the above problem, the cost of the printing apparatus increases, the running cost in printing increases, or the productivity in printing decreases. In contrast, the printing system 100 which does not use liquid white ink reduces at least any of the effects of an increase in the cost of the printing apparatus, an increase in the running cost, and a decrease in productivity.

Next, another embodiment of the printing system 100 will be described. The printing system 100 includes a printing apparatus 102A in place of the printing apparatus 102 in FIG. 1. The printing system 100 of the present embodiment forms a base of an image and expresses a white portion in the image by white powder applied onto the transfer film F by the powder application apparatus 103.

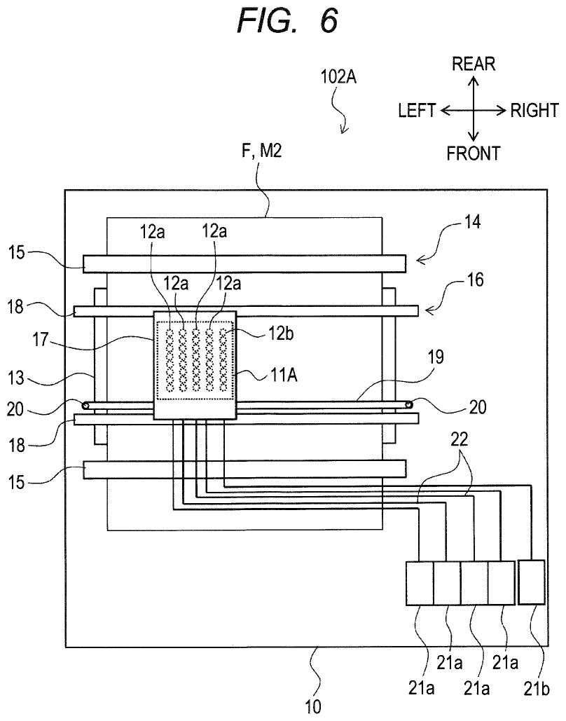

FIG. 6 illustrates the configuration of the printing apparatus 102A. The printing system 100 according to the present embodiment includes the same printing data generation apparatus 101, the powder application apparatus 103, and the thermal transfer apparatus 104 as described with reference to FIG. 1, but includes the printing apparatus 102A different from the printing apparatus 102. That is, the printing apparatus 102A shown in FIG. 6 is substantially the same as the printing apparatus 102 shown in FIG. 2, but the configuration of the inkjet head is different. This point will be described below.

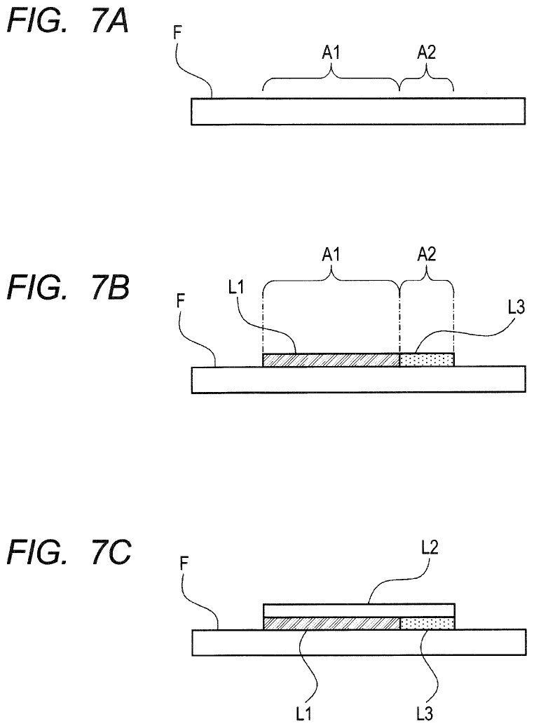

As shown in FIG. 6, the printing apparatus 102A includes an inkjet head 11A. The inkjet head 11A includes second nozzles 12b in addition to the first nozzles 12a described with reference to FIG. 2. The plurality of second nozzles 12b are arranged in a nozzle row along the front-rear direction, and the nozzle row formed by the second nozzles 12b is arranged in parallel with and rightward of the nozzle rows formed by the first nozzles 12a. The second nozzles 12b are nozzles for ejecting a light-transmissive liquid to a second image region A2 (see FIG. 7B), which is a different region from the first image region A1, in the transfer film F. The printing apparatus 102A also includes a tank 21b for storing the light-transmissive liquid corresponding to the second nozzles 12b.

The configuration of the printing apparatus 102A shown in FIG. 6 is an example, and the configuration of the printing apparatus 102A is not limited to that shown in FIG. 6. For example, in the inkjet head 11A, the nozzle row of the second nozzles 12b may be disposed forward or rearward of the nozzle rows of the first nozzles 12a. The inkjet head having the first nozzles 12a and the inkjet head having the second nozzles 12b may be formed separately from each other.

The light-transmissive liquid ejected from the second nozzles 12b is typically a colorless transparent liquid, and a solvent used for mixing the coloring material in the color ink may be employed. However, the light-transmissive liquid is not limited to this, and any liquid having a light-transmitting property of transmitting at least the color of the white powder may be used. Therefore, the light-transmissive liquid may be a liquid containing a small amount of coloring material, for example, and having a slight color. The light-transmissive liquid may be in a state of having a light-transmitting property of transmitting the color of the white powder at least after the thermal transfer to the transfer medium M1. Therefore, the color before the thermal transfer is not particularly limited, and the color may not have the light-transmitting property as described above.

FIGS. 7A to 7C illustrate layers formed on the transfer film F when the printing system 100 according to the present embodiment executes the image forming step and the powder application step. As shown in FIG. 7A, in addition to the first image region A1, the second image region A2 different from the first image region A1 is present in one main surface of the transfer film F.

The first image region A1 is a region where color ink is ejected from the first nozzles 12a by the printing apparatus 102A based on print data. Therefore, as shown in FIG. 7B, a color ink layer L1 including the landed color ink is formed in the first image region A1. The second image region A2 is a region where the light-transmissive liquid is ejected from the second nozzles 12b by the printing apparatus 102A based on the print data. As shown in FIG. 7B, a light-transmissive liquid layer L3 is formed in the second image region A2.

The first image region A1 corresponds to a chromatic color portion and a black portion other than a white portion in an image to be transferred. The second image region A2 corresponds to the white portion of the image to be transferred.

After the color ink layer L1 and the light-transmissive liquid layer L3 are formed on the transfer film F, the white powder and the adhesive powder are applied onto the transfer film F by the powder application apparatus 103. That is, the transfer film F passes below the drum 30 before the surfaces of the color ink layer L1 and the light-transmissive liquid layer L3 are dried. Thus, the white powder and the adhesive powder are applied onto the color ink layer L1 and the light-transmissive liquid layer L3. As a result, as shown in FIG. 7C, the white adhesive layer L2 including a white coloring material and an adhesive is formed on the color ink layer L1 and the light-transmissive liquid layer L3. In FIG. 7C, a state is schematically shown in which the transfer film F is heated after the white powder and the adhesive powder are applied, and the adhesive powder is melted and fixed on the transfer film F.

Thereafter, the image on the transfer film F is transferred to a particular position of the transfer medium M1 by using the transfer film F on which the layers L1 to L3 are formed, as described above. Thus, an image is formed on the transfer medium M1.

In the image transferred to the transfer medium M1, a portion of the white adhesive layer L2 (forming the base) corresponding to the light-transmissive liquid layer L3 is seen through the light-transmissive liquid layer L3. Therefore, the color of the white portion in the image is represented by the white color of the white powder. Thus, in addition to the liquid white ink for forming the base of the image, no liquid white ink is used for expressing the white region in the image. Therefore, one or more of the above-described disadvanrages of the use of liquid white ink is reduced.

Next, still another embodiment of the printing system 100 will be described. The printing system 100 includes a printing apparatus 102B in place of the printing apparatus 100 in FIG. 1. The printing system 100 is also capable of forming an image by directly ejecting ink onto the print medium M2 such as a towel, clothes, and bag, without performing transfer using the transfer film F.

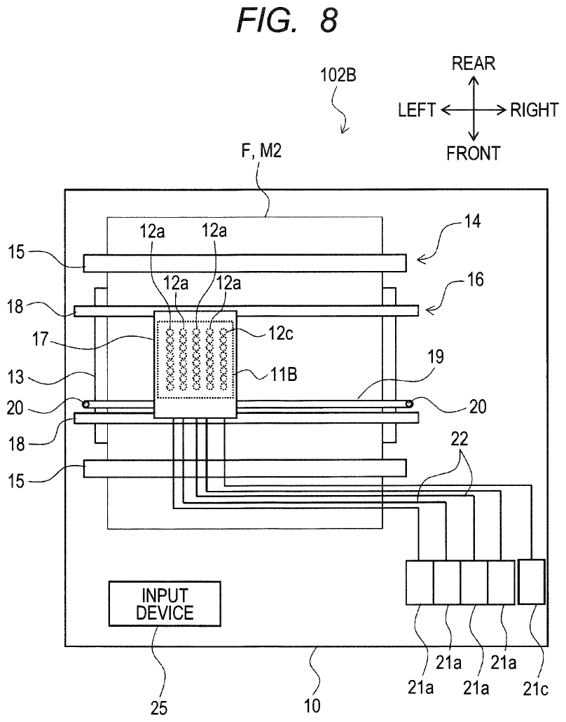

FIG. 8 illustrates the configuration of the printing apparatus 102B. The printing system 100 according to the present embodiment includes the same printing data generation apparatus 101, the powder application apparatus 103, and the thermal transfer apparatus 104 as described with reference to FIG. 1, but includes the printing apparatus 102B different from the printing apparatus 102. That is, the printing apparatus 102B shown in FIG. 8 is substantially the same as the printing apparatus 102 shown in FIG. 2, but the configuration of the inkjet head is different. This point will be described below.

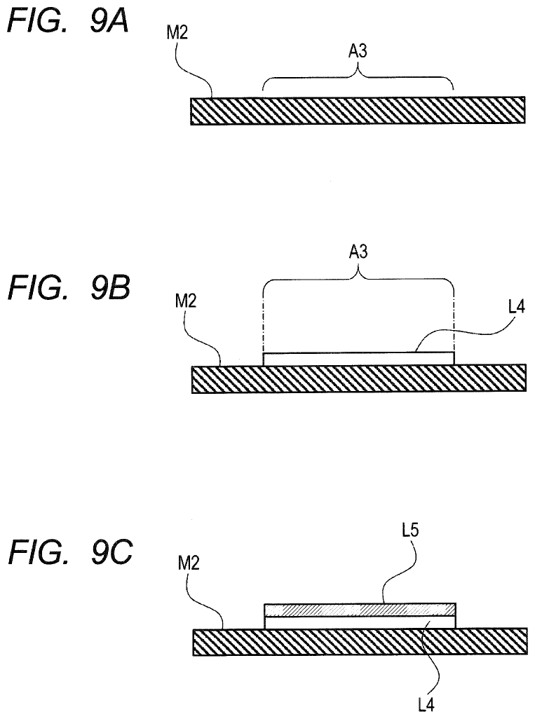

As shown in FIG. 8, the printing apparatus 102B includes an inkjet head 11B. The inkjet head 11B includes third nozzles 12c in addition to the first nozzles 12a described with reference to FIG. 2. The plurality of third nozzles 12c are arranged in a nozzle row along the front-rear direction, and the nozzle row formed by the third nozzles 12c is arranged in parallel with and rightward of the nozzle rows formed by the first nozzles 12a. The third nozzles 12c are nozzles that eject a liquid white ink to a third image region A3 (see FIG. 9A), which is a region on the print medium M2. The printing apparatus 102B also includes a tank 21c for storing white ink in a liquid state, corresponding to the third nozzles 12c.

The configuration of the printing apparatus 102B shown in FIG. 8 is an example, and the configuration of the printing apparatus 102B is not limited to that shown in FIG. 8. For example, in the inkjet head 11B, the nozzle row of the third nozzles 12c may be disposed forward or rearward of the nozzle rows of the first nozzles 12a. The inkjet head including the first nozzles 12a and the inkjet head including the third nozzles 12c may be formed separately from each other.

FIGS. 9A to 9C illustrate layers formed on the print medium M2 when an image is directly formed on the print medium M2 by the printing system 100 according to the present embodiment. As shown in FIG. 9A, the third image region A3 is present on the print medium M2. The third image region A3 is a region where white ink is ejected from the third nozzles 12c by a printing apparatus 103B based on the print data. Therefore, as shown in FIG. 9B, a white ink layer L4 including the landed white ink is formed in the third image region A3.

The printing apparatus 102B ejects color ink from the first nozzles 12a onto the white ink ejected to the third image region A3, that is, onto the white ink layer L4 to form an image. Therefore, as shown in FIG. 9C, a color ink layer L5 including color ink is formed on the white ink layer L4. Thus, the printing apparatus 102B directly forms an image having a white base on the print medium M2. That is, the printing apparatus 102B according to the present embodiment includes a similar configuration to the printing apparatus 102 of FIG. 2, and also includes the third nozzles 12c for ejecting the liquid white ink.

Therefore, the printing system 100 according to the present embodiment selectively uses two printing methods, namely, a method of forming an image on the transfer medium M1 by a transfer method not using a liquid white ink (transfer printing method) and a method of forming an image by directly ejecting ink to the print medium M2 using a liquid white ink (direct printing method).

More specifically, as shown in FIG. 8, the printing apparatus 102B includes an input device 25 including a liquid crystal touch panel display, for example, and is operable by a user. The user operates the input device 25 to select the printing method from among the transfer printing method and the direct printing method and to perform printing by the selected method on the printing apparatus 102B.

For example, when the user operates the input device 25 to select the transfer printing method, the printing system 100 executes the transfer printing method by the procedure described with reference to FIGS. 4 and 5A to 5C or the procedure described with reference to FIGS. 7A to 7C. When the user operates the input device 25 to select the direct printing method (that is, when the user selects to form an image on the print medium M2 without forming an image on the transfer film F), the printing system 100 executes the direct printing method by the procedure as described with reference to FIGS. 9A to 9C. The input device for selecting the printing method is not limited to the input device 25 disposed in the printing apparatus 102B. For example, an apparatus other than the printing apparatus 102B, such as the print data generation apparatus 101 or a personal computer, which communicates with the printing apparatus 102B, may include an input device.

The present disclosure is applicable to a printing system configured to transfer an image formed on a transfer film to a transfer medium, a printing method, and a mixed powder that is usable in the printing system and the printing method.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided as appropriate.

What is claimed is

1. A printing system comprising:
an inkjet head including a first nozzle configured to eject color ink to a first image region of a transfer film to form an image to be transferred to a transfer medium; and
a powder application apparatus configured to apply a white powder and an adhesive powder onto the color ink ejected to the first image region.

2. The printing system according to claim 1, wherein the inkjet head includes a second nozzle configured to eject light-transmissive liquid to a second image region different from the first image region of the transfer film, the light-transmissive liquid transmitting a color of the white powder; and
wherein the powder application apparatus applies the white powder and the adhesive powder onto the light-transmissive liquid ejected to the second image region.

3. The printing system according to claim 1, wherein the powder application apparatus applies mixed powder onto the color ink ejected to the first image region, the mixed powder being a mix of the white powder and the adhesive powder.

4. The printing system according to claim 1, wherein the powder application apparatus applies white adhesive powder onto the color ink ejected to the first image region, the white adhesive powder being a plurality of adhesive particles containing a white coloring material, the white adhesive powder serving as the white powder and the adhesive powder.

5. The printing system according to claim 3, wherein a specific gravity of particles forming the white powder in the mixed powder is larger than a specific gravity of particles forming the adhesive powder, and an average particle size of the particles forming the white powder is smaller than an average particle size of the particles forming the adhesive powder.

6. The printing system according to claim 1, wherein the inkjet head includes a particular nozzle configured to eject white ink in a liquid state to a particular image region of a print medium; and
wherein, when the image is formed on the print medium without being formed on the transfer film, the particular nozzle ejects the white ink to the particular image region of the print medium, and the first nozzle ejects color ink onto the white ink ejected to the particular image region.

7. The printing system according to claim 1, further comprising:
a thermal transfer apparatus configured to transfer the image on the transfer film to the transfer medium, the thermal transfer apparatus including a heat press, the adhesive powder, when heated by the heat press, causing the white powder to adhere to the transfer medium, the white powder serving as a base of the image that is transferred.

8. A printing method comprising:
ejecting color ink to a first image region of a transfer film to form an image to be transferred to a transfer medium; and
applying a white powder and an adhesive powder onto the color ink ejected to the first image region.

9. The printing method according to claim 8, further comprising:
ejecting, from a second nozzle of the inkjet head, light-transmissive liquid to a second image region different from the first image region of the transfer film, the light-transmissive liquid transmitting a color of the white powder; and
wherein the applying includes applying the white powder and the adhesive powder onto the light-transmissive liquid ejected to the second image region.

10. The printing method according to claim 8, wherein the applying includes applying mixed powder onto the color ink ejected to the first image region, the mixed powder being obtained by mixing the white powder and the adhesive powder.

11. The printing method according to claim 8, wherein the applying includes applying a white adhesive powder onto the color ink ejected to the first image region, the white adhesive powder being a plurality of adhesive particles containing a white coloring material, the white adhesive powder serving as the white powder and the adhesive powder.

12. The printing method according to claim 10, wherein a specific gravity of particles forming the white powder in the mixed powder is larger than a specific gravity of particles forming the adhesive powder, and an average particle size of the particles forming the white powder is smaller than an average particle size of the particles forming the adhesive powder.

13. The printing method according to claim 8, further comprising:
ejecting, from a particular nozzle of the inkjet head, white ink in a liquid state to a particular image region of a print medium;
when the image is formed on the print medium without being formed on the transfer film, ejecting, from the particular nozzle, the white ink to the particular image region of the print medium; and
ejecting, from the first nozzle, color ink onto the white ink ejected to the particular image region.

14. The printing method according to claim 8, further comprising:
transferring, by a thermal transfer apparatus including a heat press, the image on the transfer film to the transfer medium, the adhesive powder, when heated by the heat press, causing the white powder to adhere to the transfer medium, the white powder serving as a base of the image that is transferred.

15. A mixed powder to be applied onto an image to be transferred to a transfer medium, the mixed powder comprising:
a white powder to be applied onto color ink ejected to a transfer film from an inkjet head; and
an adhesive powder that causes the white powder to adhere to the transfer medium.

16. The mixed powder according to claim 15, wherein a specific gravity of particles forming the white powder in the mixed powder is larger than a specific gravity of particles forming the adhesive powder, and an average particle size of the particles forming the white powder is smaller than an average particle size of the particles forming the adhesive powder.
